(19) United States
(12) Patent Application Publication
(10) Pub. No.: US 2025/0192378 A1
(43) Pub. Date: Jun. 12, 2025

(54) TRACTION BATTERY PACK TERMINAL CLAMP AND CLAMPING METHOD

(71) Applicant: Ford Global Technologies, LLC, Dearborn, MI (US)

(72) Inventor: Kanchana Perumalla, Troy, MI (US)

(21) Appl. No.: 18/802,428

(22) Filed: Aug. 13, 2024

Related U.S. Application Data
(60) Provisional application No. 63/607,888, filed on Dec. 8, 2023.

(51) Int. Cl. H01M 50/516; B23K 26/21; H01M 50/557

(52) U.S. Cl. CPC H01M 50/516; B23K 26/21; H01M 50/557; H01M 2220/20

(57) ABSTRACT

A method of assembling a battery pack includes inserting at least one terminal through a slot of a cross-member assembly, folding the at least one terminal over a busbar of the cross-member assembly, pressing the at least one terminal against the busbar using a clamping fixture, and securing the at least one terminal to the busbar through at least one aperture in the clamping fixture.

### CROSS-REFERENCE TO RELATED APPLICATIONS

This disclosure claims priority to U.S. Provisional Application No. 63/607,888, which was filed on Dec. 8, 2023, and is incorporated herein by reference in its entirety.

### TECHNICAL FIELD

This disclosure relates generally to securing tab terminals when assembling of a traction battery pack.

### BACKGROUND

Electrified vehicles differ from conventional motor vehicles because electrified vehicles can be selectively driven by one or more electric machines that are powered by a traction battery pack. The electric machines can propel the electrified vehicles instead of, or in combination with, an internal combustion engine. The traction battery pack is discharged when powering the one or more electric machines and other loads of the electrified vehicle.

### SUMMARY

In some aspects, the techniques described herein relate to a method of assembling a battery pack, including: inserting at least one terminal through a slot of a cross-member assembly; folding the at least one terminal over a busbar of the cross-member assembly; pressing the at least one terminal against the busbar using a clamping fixture; and securing the at least one terminal to the busbar through at least one aperture in the clamping fixture.

In some aspects, the techniques described herein relate to a method, further including securing the at least one terminal to the busbar by welding the at least one terminal to the busbar.

In some aspects, the techniques described herein relate to a method, wherein the welding is laser welding.

In some aspects, the techniques described herein relate to a method, wherein the at least one aperture includes a tapered opening that at least partially receives a welder during the welding.

In some aspects, the techniques described herein relate to a method, wherein the at least one aperture includes a plurality of elongated slots each elongated slot with the plurality of elongated slots having a long dimension and a short dimension.

In some aspects, the techniques described herein relate to a method, further including securing the at least one terminal to the busbar by welding the at least one terminal to the busbar, the welding include at least one linearly extending weld applied through each elongated slot within the plurality of elongated slots and aligned with the long dimension of the respective elongated slot.

In some aspects, the techniques described herein relate to a method, wherein the clamping fixture includes a collar about the at least one aperture, the collar projecting from a side of the clamping fixture that faces the at least one terminal when pressing the at least one terminal against the busbar.

In some aspects, the techniques described herein relate to a method, further including securing the clamping fixture to the cross-member assembly during the pressing.

In some aspects, the techniques described herein relate to a method, further including securing the clamping fixture to the cross-member assembly using at least one mechanical fastener.

In some aspects, the techniques described herein relate to a method further including removing the clamping fixture from the cross-member after the securing.

In some aspects, the techniques described herein relate to a method, wherein the clamping fixture is part of a welder that welds the at least one terminal to the busbar during the securing.

In some aspects, the techniques described herein relate to a method, wherein the at least one terminal is at least one terminal of a pouch-style battery cells.

In some aspects, the techniques described herein relate to a method, wherein a rib circumscribes a periphery of the at least one aperture and is configured to directly contact the at least one terminal when the clamping fixture is pressing the at least one terminal against the busbar.

In some aspects, the techniques described herein relate to a method, wherein the clamping fixture includes at least airflow opening.

In some aspects, the techniques described herein relate to a traction battery pack assembly, including: a clamping fixture that presses at least one terminal against a busbar of a cross-member assembly, the terminal clamping fixture having at least one aperture through which the terminal can be accessed to secure the at least one terminal against the busbar.

In some aspects, the techniques described herein relate to a traction battery pack assembly, wherein the clamping fixture is configured to be removably secured directly to the cross-member when pressing the at least one terminal against the busbar.

In some aspects, the techniques described herein relate to a traction battery pack assembly, wherein at least a portion of the at least one aperture is tapered toward the at least terminal when the clamping fixture is pressing the at least one terminal against the busbar.

In some aspects, the techniques described herein relate to a traction battery pack assembly, wherein the at least one aperture includes at least one elongated slot.

In some aspects, the techniques described herein relate to a traction battery pack assembly, wherein the clamping fixture includes at least one rib circumscribing the at least one aperture.

In some aspects, the techniques described herein relate to a traction battery pack assembly, wherein the clamping fixture includes at least airflow opening.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates an expanded, perspective view of a battery pack from the electrified vehicle of FIG. 1.

FIG. 3 illustrates a perspective view of a battery cell from the battery pack of FIG. 2.

FIG. 4 illustrates a close-up view of an area of FIG. 2 showing a cross-member assembly and tab terminals of battery cells prior to the tab terminals being pressed against busbars of the cross-member assembly with a clamping assembly.

FIG. 5 illustrates the close-up view of the area of FIG. 2 showing the clamping assembly secured to the cross-member assembly and pressing the tab terminals against the busbars.

FIG. 6 illustrates the close-up view of the area of FIG. 2 showing the clamping assembly removed from the cross-member assembly and the tab terminals secured to the busbars with welds.

FIG. 7 is a front view of the clamping assembly of FIG. 5.

FIG. 8 is a section view at line 8-8 in FIG. 7.

FIG. 9 is a front view of a clamping assembly according to another exemplary embodiment of the present disclosure.

FIG. 10 is a section view at line 10-10 in FIG. 7.

FIG. 11 is a front view of a clamping assembly according to another exemplary embodiment of the present disclosure.

FIG. 12 is a section view at line 12-12 in FIG. 11.

### DETAILED DESCRIPTION

This disclosure details example assembly methods and assembly aids that can be used to facilitate terminals of a traction battery pack. The terminals can be secured to busbars of a cross-member assembly, for example.

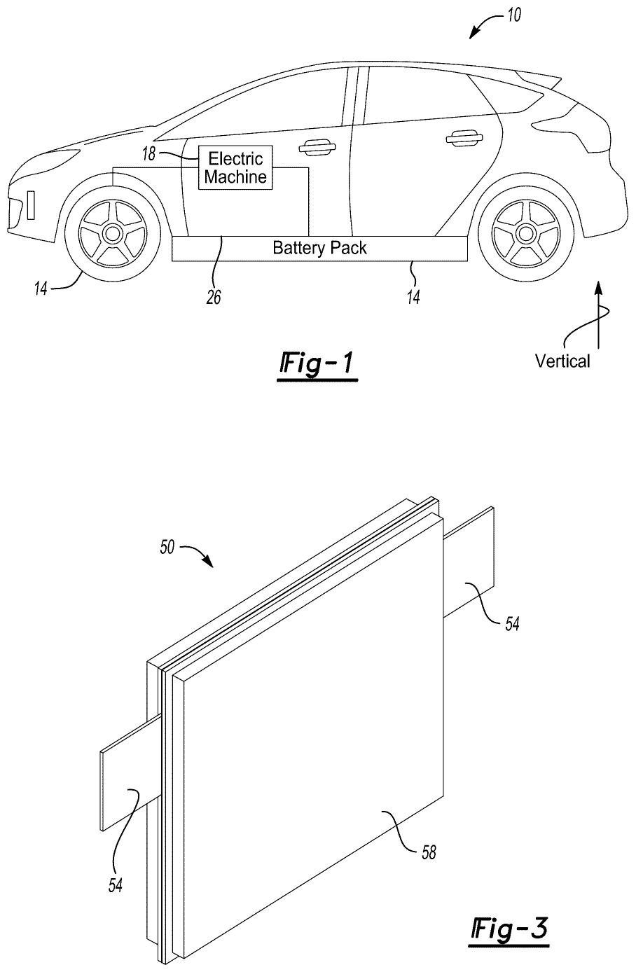

With reference to FIG. 1, an electrified vehicle 10 includes a battery pack 14, an electric machine 18, and wheels 22. The battery pack 14 powers an electric machine 18, which can convert electrical power to mechanical power to drive the wheels 22. The battery pack 14 is thus a traction battery pack.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

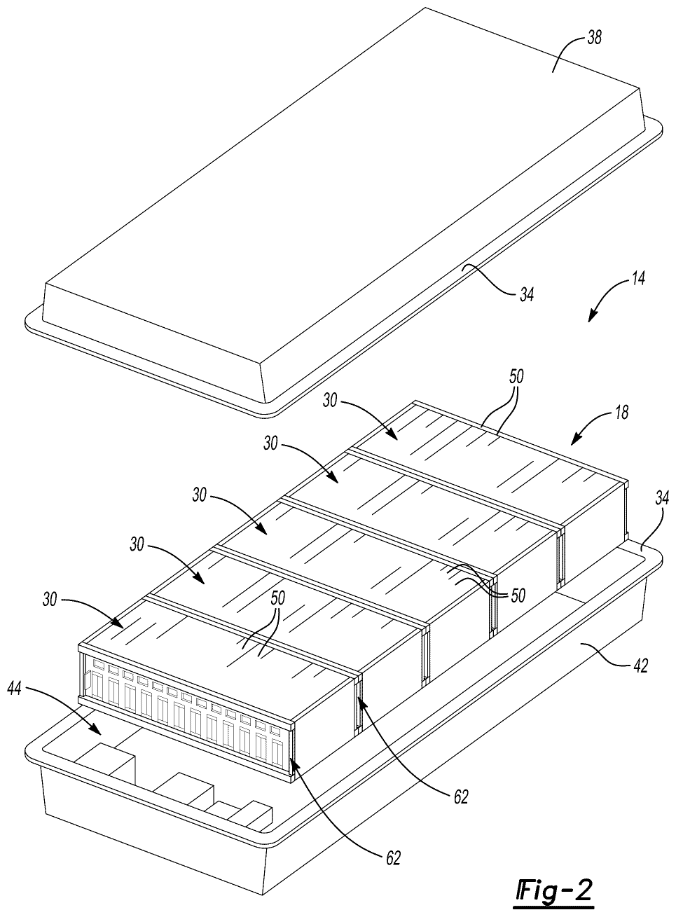

With reference now to FIGS. 2 to 4, the battery pack 14 includes a plurality of cell stacks 30 held within an enclosure assembly 34. In the exemplary embodiment, the enclosure assembly 34 includes an enclosure cover 38 and an enclosure tray 42. The enclosure cover 38 can be secured to the enclosure tray 42 to provide an interior area 44 that houses the cell stacks 30. The enclosure cover 38 can be secured to the enclosure tray 42 using mechanical fasteners (not shown), for example.

Each of the cell stacks 30 includes, among other things, a plurality of battery cells 50 (or simply “cells”) stacked side-by-side relative to each along a respective cell stack axis. The battery cells 50 store and supply electrical power. Although a specific number of the cell stacks 30 and cells 50 are illustrated in the various figures of this disclosure, the battery pack 14 could include any number of the cell stacks 30 each having any number of individual cells 50.

In an embodiment, the battery cells 50 are lithium-ion pouch-style cells. However, battery cells having other geometries (cylindrical, prismatic, etc.), other chemistries (nickel metal hydride, lead acid, etc.), or both could be alternatively utilized within the scope of this disclosure.

With the cell stacks 30, the individual battery cells 50 can be electrically connected together. The cell stacks 30 can also be connected to each other. To facilitate these electrical connections, the battery cells 50 each include a pair of tab terminals 54 extending from a case 58. The tab terminals 54 of the battery cells 50 can be connected to the tab terminals 54 of other battery cells 50 and to other structures.

For instance, alongside the battery cells 50 are cross-member assemblies 62. Each cell stack 30 is positioned between two cross-member assemblies 62 in this example. The example cross-member assemblies 62 each include a frame 66, a first beam 70, a second beam 74, and a plurality of busbars 78.

In the exemplary embodiment, the busbars 78 are heat-staked to the frame 66, which is a polymer-based material. The frame 66 could be injection molded. The frame 66, the first beam 70, and the second beam 74 extend longitudinally a length of the cell stack 30. The first beam 70 and the second beam 74 are pultruded beams in this example. The first beam 70 and the second beam 74 can be adhesively secured to the frame 66.

When the cell stacks 30 are assembled, the tab terminals 54 extend through a plurality of slots 82 in the frame 66. The tab terminals 54 are folded over the busbars 78 and are secured to the busbars 78 via welds, for example.

The tab terminals 54 are typically thin strips of foil. The tab terminals 54 can be, for example, copper foil or aluminum foil.

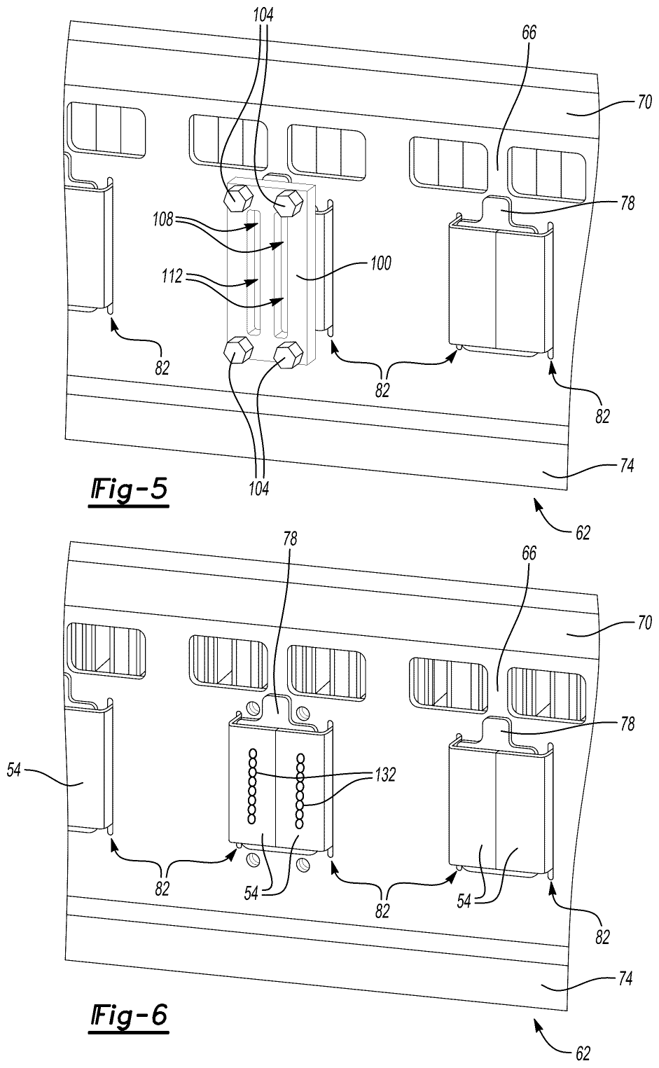

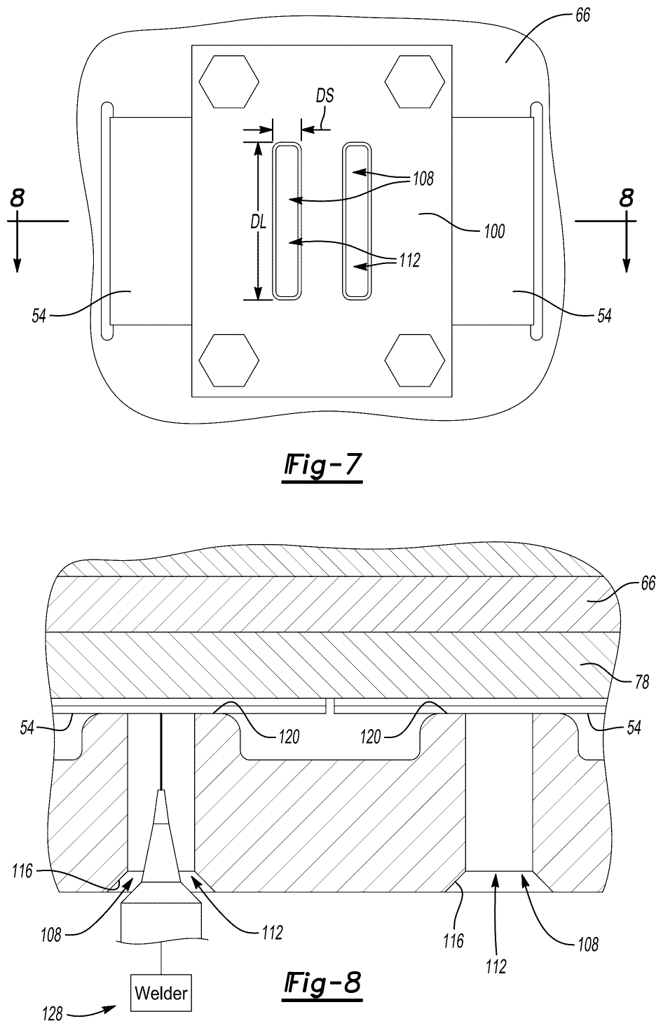

With reference to FIGS. 5-8 and continuing reference to FIGS. 2-4, exemplary embodiments of this disclosure utilize a clamping fixture 100 to help position the tab terminals 54 when securing the tab terminals 54 to the busbars 78.

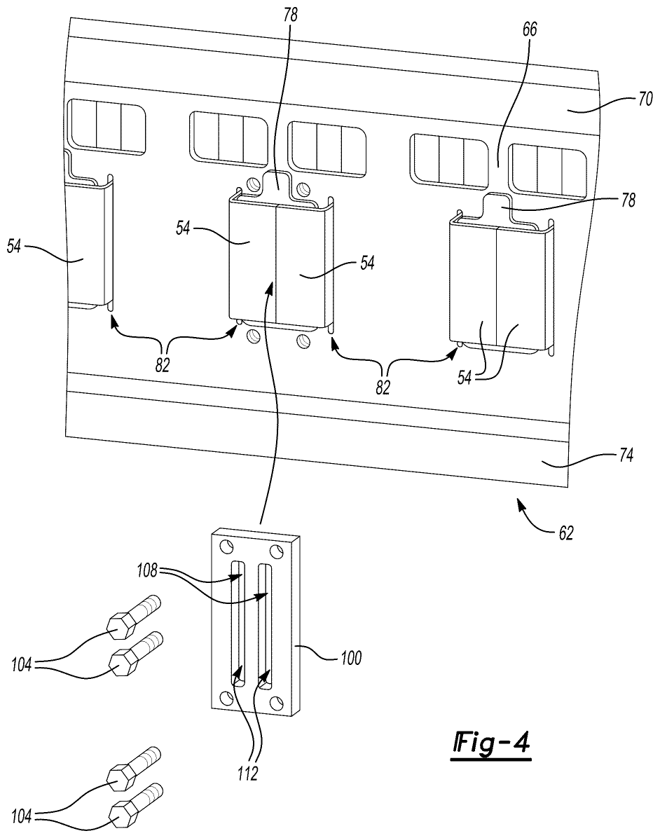

In this example, the clamping fixture 100 is secured to the cross-member assembly 62 after the tab terminals 54 are positioning within respective slots 82 and folded over the respective busbars 78 as shown in FIG. 4. The clamping fixture 100 is secured to the cross-member assembly 62 before securing the tab terminals 54 to the busbars 78 as shown in FIG. 5.

In this example, after folding the tab terminals 54 over the respective busbars 78, the clamping fixture 100 is secured to the frame 66 of the cross-member assembly 62 using a plurality of mechanical fasteners 104, which are threaded fasteners in this example.

The clamping fixture 100 includes a plurality of apertures 108. In this example the plurality of apertures 108 are elongated slots 112 each having a long dimension DL and a short dimension DS. The slots 112 each include a tapered opening portion 116.

On a side of the clamping fixture 100 that faces the tab terminals 54, the clamping fixture 100 includes collars 120 (or ribs) about each of the elongated slots 112. The collars 120 are substantially ribs that circumscribe a periphery of each of the elongated slots 112. The collars 120 project from the surrounding areas of the clamping fixture 100. As the clamping fixture 100 is secured to the frame 66 with the mechanical fasteners 104, the collars 120 directly contact the tab terminals 54 and clamp or press the tab terminals 54 against the respective busbar 78. The use of the collars 120 helps to increase the clamping force on the tab terminals 54.

In this example, a welder 128 is then at least partially inserted into the elongated slot 112 and secures the tab terminals 54 to the busbar 78 via, in this example, at least one linearly extending weld 132 that is generally aligned with the long dimension DL of the elongated slots 112 as shown in FIG. 6. A shape or provide of the apertures 108 generally tracks a desired pattern for the weld 132. In this example, the welder 128 is a laser welder and the welds 132 are laser welds. The apertures 108—here the at least one elongated slot 112—provide access to the tab terminals 54.

The tapered opening portion 116 can help to guide the welder 128 into the elongated slots 112 during welding.

Pressing the tab terminals 54 against the respective busbar 78 with the clamping fixture 100 applies a positive clamping force to the tab terminals 54 and can close gaps between the tab terminals 54 and the busbars 78 when securing the tab terminals 54 to the busbars 78.

The clamping fixture 100 can include airflow openings in the collars 120, in another portion of the clamping fixture 100, or both to allow airflow during welding and to facilitate thermal energy transfer away from the weld 132.

After welding, the welder 128 is withdrawn from the aperture 108. The mechanical fasteners 104 can then be detached from the frame 66 and the clamping fixture 100 removed leaving behind the tab terminals 54 attached to the busbars 78.

The example clamping fixture 100 is secured to the frame 66 when welding the tab terminals 54. In another example, the clamping fixture 100 could be part of the welder 128 and can remain detached from the frame 66 during welding. Instead, in such an example, the clamping fixture 100 presses the tab terminals 54 against the respective busbar 78 as the welder 128 is moved toward the busbars 78.

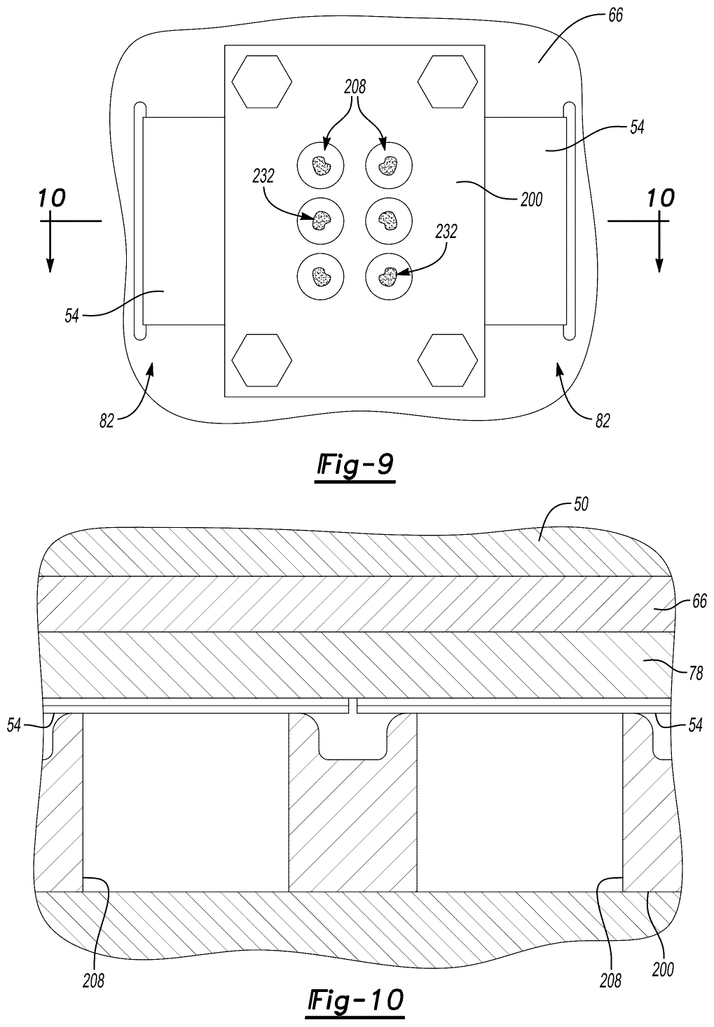

With reference to FIGS. 9 and 10, another example clamping fixture 200 includes a plurality of apertures 208, which are a series of cylindrical bores. Welds 232 having a circular shape can be applied through the apertures 208 to secure the tab terminals 54 to the busbars 78.

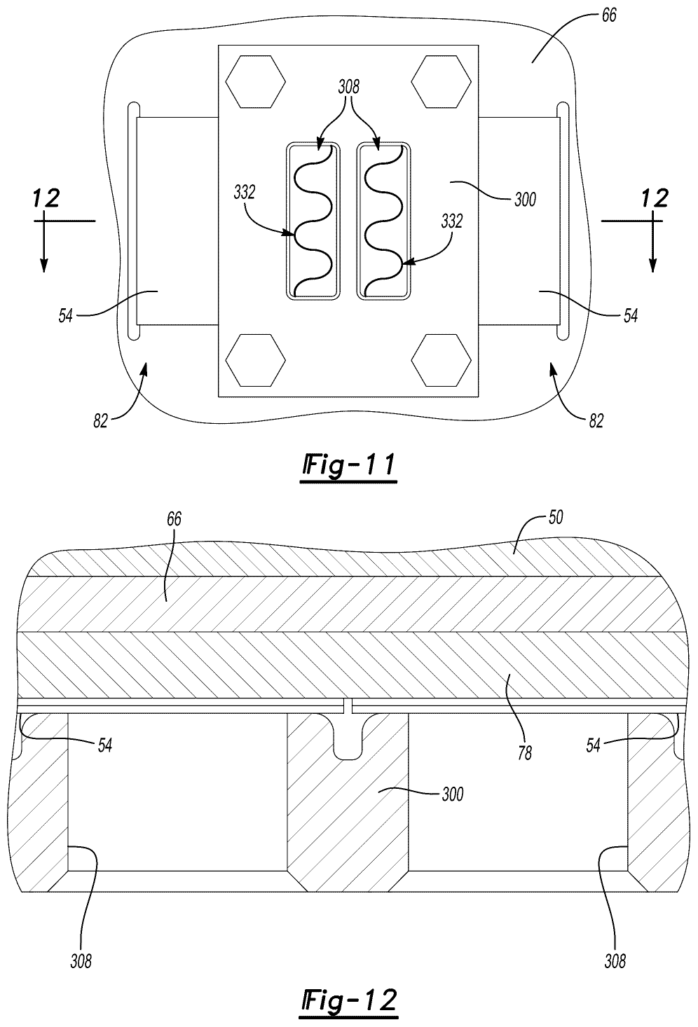

With reference to FIGS. 11 and 12, yet another example clamping fixture 300 includes a plurality of apertures 308, which, in this example, are slots that are wider than the apertures 108 of the embodiment of FIGS. 5-7. Weld 332 having a sinusoid pattern can be applied through the apertures 308 to secure the tab terminals 54 to the busbars 78.

Features of this disclosure include using a clamping fixture to facilitate robustly securing terminals to a busbar. The clamping fixture can include openings that are adapted to receive a welder that applies a weld in a particular type of pattern.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A method of assembling a battery pack, comprising:
inserting at least one terminal through a slot of a cross-member assembly;
folding the at least one terminal over a busbar of the cross-member assembly;
pressing the at least one terminal against the busbar using a clamping fixture; and
securing the at least one terminal to the busbar through at least one aperture in the clamping fixture.

2. The method of claim 1, further comprising securing the at least one terminal to the busbar by welding the at least one terminal to the busbar.

3. The method of claim 2, wherein the welding is laser welding.

4. The method of claim 2, wherein the at least one aperture includes a tapered opening that at least partially receives a welder during the welding.

5. The method of claim 2, wherein the at least one aperture comprises a plurality of elongated slots each elongated slot with the plurality of elongated slots having a long dimension and a short dimension.

6. The method of claim 5, further comprising securing the at least one terminal to the busbar by welding the at least one terminal to the busbar, the welding include at least one linearly extending weld applied through each elongated slot within the plurality of elongated slots and aligned with the long dimension of the respective elongated slot.

7. The method of claim 1, wherein the clamping fixture includes a collar about the at least one aperture, the collar projecting from a side of the clamping fixture that faces the at least one terminal when pressing the at least one terminal against the busbar.

8. The method of claim 1, further comprising securing the clamping fixture to the cross-member assembly during the pressing.

9. The method of claim 5, further comprising securing the clamping fixture to the cross-member assembly using at least one mechanical fastener.

10. The method of claim 6 further comprising removing the clamping fixture from the cross-member after the securing.

11. The method of claim 1, wherein the clamping fixture is part of a welder that welds the at least one terminal to the busbar during the securing.

12. The method of claim 1, wherein the at least one terminal is at least one terminal of a pouch-style battery cells.

13. The method of claim 1, wherein a rib circumscribes a periphery of the at least one aperture and is configured to directly contact the at least one terminal when the clamping fixture is pressing the at least one terminal against the busbar.

14. The method of claim 13, wherein the clamping fixture includes at least one airflow opening.

15. A traction battery pack assembly, comprising:
a clamping fixture that presses at least one terminal against a busbar of a cross-member assembly, the terminal clamping fixture having at least one aperture through which the terminal can be accessed to secure the at least one terminal against the busbar.

16. The traction battery pack assembly of claim 15, wherein the clamping fixture is configured to be removably secured directly to the cross-member when pressing the at least one terminal against the busbar.

17. The traction battery pack assembly of claim 15, wherein at least a portion of the at least one aperture is tapered toward the at least terminal when the clamping fixture is pressing the at least one terminal against the busbar.

18. The traction battery pack assembly of claim 15, wherein the at least one aperture comprises at least one elongated slot.

19. The traction battery pack assembly of claim 15, wherein the clamping fixture includes at least one rib circumscribing the at least one aperture.

20. The traction battery pack assembly of claim 15, wherein the clamping fixture includes at least airflow opening.
